(19) United States
(12) Patent Application Publication
(10) Pub. No.: US 2026/0178138 A1
(43) Pub. Date: Jun. 25, 2026

(54) CONTROL KNOB FOR A HANDHELD COMMUNICATION DEVICE

(71) Applicant: MOTOROLA SOLUTIONS, INC., Chicago, IL (US)

(72) Inventors: Felippe Morais Bicudo, Ave Maria, FL (US); Steve Aviton, Coral Springs, FL (US); Jin Siang Chew, Lake Worth, FL (US); Jari P. Jarvinen, Coral Springs, FL (US); Anthony M. Kakiel, Coral Springs, FL (US); Ryan M. Nilsen, Plantation, FL (US)

(21) Appl. No.: 18/999,185

(22) Filed: Dec. 23, 2024

(51) Int. Cl. G06F 3/0362

(52) U.S. Cl. CPC G06F 3/0362

(57) ABSTRACT

The present disclosure provides a handheld electronic communication device comprising a first control knob having a first rotational axis on a first plane, and a second control knob having a second rotational axis on a second plane. The first and second planes are oblique to one another when viewed from every direction. The device may include a housing with a rear surface defining a third plane parallel to the first plane and oblique to the second plane. The second control knob may have a base portion and a top portion separated from the third plane by different distances. The device may further include a control interface with an edge portion and a hollow shroud enveloping a portion of the second control knob. A selector switch may be positioned between the first and second control knobs.

### BACKGROUND OF THE INVENTION

Electronic devices, for example, portable two-way radios, use rotary switches to activate and control various functions, such as volume and channel control. Such electronic devices have been decreasing in size, while still having multiple switches or rotary control knobs for control.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments, examples, aspects, and features of concepts that include the claimed subject matter and explain various principles and advantages of those embodiments, examples, aspects, and features.

FIG. 1 illustrates a block diagram of an electronic device, according to aspects of the present disclosure.

FIG. 2 illustrates a perspective view of the electronic device of FIG. 1, according to an embodiment.

FIG. 3 illustrates a side orthogonal view of the electronic device of FIG. 1, according to aspects of the present disclosure.

FIG. 4 illustrates a front orthogonal view of the electronic device of FIG. 1, according to an embodiment.

FIG. 5 illustrates a top view of the electronic device of FIG. 1, according to aspects of the present disclosure.

FIG. 6 illustrates a side view of the electronic device of FIG. 1, according to an embodiment.

FIG. 7 illustrates a front orthogonal view of the electronic device of FIG. 1, according to aspects of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples, aspects, and features illustrated.

In some instances, the apparatus and method components have been represented where appropriate by conventional symbols in the drawings, showing only those specific details that are pertinent to understanding the of various embodiments, examples, aspects, and features so as not to obscure the disclosure with details that will be readily apparent to those of ordinary skill in the art having the benefit of the description herein.

### DETAILED DESCRIPTION OF THE INVENTION

Electronic devices, for example, portable two-way radios, use rotary switches to activate and control various functions, such as volume and channel control. As electronic devices decrease in size, it is increasingly difficult to locate multiple switches or rotary control knobs on a single device. Locating the controls near one another makes it difficult for users to manipulate them. For example, a user attempting to activate one control may inadvertently activate an adjacent control. In addition, including multiple rotary controls may lead to inefficient use of space within electronic devices. Multi-function rotary controls take less space than multiple controls, but do not clearly identify which function they are controlling.

Handheld communication devices, such as two-way radios, cellular phones, and smartphones, often require multiple control inputs to manage various functions, including volume adjustment, channel selection, and power control. As such devices become more compact, it becomes difficult to arrange control elements in a way that maintains usability without compromising the device's form factor. The placement of rotary knobs, switches, and buttons on a small surface area can lead to ergonomic issues, particularly for users operating the devices in demanding environments or while wearing protective gear such as gloves.

Traditional approaches to control interface design often involve placing multiple controls in close proximity, which can result in operational difficulties. Users may inadvertently activate the wrong control or struggle to manipulate individual controls precisely. This issue is exacerbated in situations where quick and accurate control adjustments are crucial, such as in emergency response scenarios or industrial settings. Other approaches involve increasing the size of the controls to make them easier to grip with gloved hands. However, this may reduce spacing between some controls and limit access to other controls.

Furthermore, the reduction in device size can limit the options for control placement, potentially leading to compromises in functionality or user experience. Designers must balance the need for accessible and easily distinguishable controls with the constraints of available space on the device's surface.

Accordingly, there is a growing need for innovative control interface designs that can accommodate multiple functions within a limited space while maintaining ease of use and reducing the likelihood of user error. Such designs must consider not only the physical arrangement of controls but also their shape, size, and orientation to optimize user interaction across various operating conditions. Human factors and ergonomics play a significant role in the development of effective control interfaces for handheld communication devices. The ability to operate controls accurately and efficiently, even in high-stress situations or while wearing protective equipment, is essential for many users of these devices, including first responders, military personnel, and industrial workers.

To address, among other things, these problems, examples are provided herein for control interfaces for portable electronic communication devices. Examples presented herein include a handheld electronic communication device that incorporates a novel arrangement of control knobs to enhance user interaction and device ergonomics. Examples feature a first control knob and a second control knob, each positioned with its rotational axis on a different plane. These planes may be oriented obliquely to one another, creating a unique spatial relationship between the control elements.

This configuration offers several potential benefits for users of the handheld communication device. By positioning the control knobs on oblique planes, the device may provide improved separation between controls, potentially reducing the likelihood of accidental activation. Additionally, this arrangement may allow for more efficient use of space on the device's surface while maintaining or enhancing the accessibility and usability of the controls, even in challenging operational environments or when the user is wearing protective equipment such as gloves.

In some aspects, the techniques described herein relate to a handheld electronic communication device including: a first control knob having a first rotational axis on a first plane; and a second control knob having a second rotational axis on a second plane; wherein the first and second planes are oblique to one another when viewed from every direction.

In some aspects, the techniques described herein relate to a handheld electronic communication device, further including: a housing including a rear surface; wherein a portion of the rear surface defines a third plane parallel to the first plane and oblique to the third plane.

In some aspects, the techniques described herein relate to a handheld electronic communication device, wherein: the second control knob has a base portion separated from the third plane by a first distance and a top portion separated from the third plane by a second distance; and the second control knob is aligned to cause the second distance to be substantially greater than the first distance.

In some aspects, the techniques described herein relate to a handheld electronic communication device, further including: a housing including a control interface; wherein the first control knob and the second control knob are coupled to the control interface.

In some aspects, the techniques described herein relate to a handheld electronic communication device, wherein: the control interface includes an edge portion; the second control knob projects along the edge portion; and the housing includes a hollow shroud projecting from the control interface and enveloping a portion of the second control knob.

In some aspects, the techniques described herein relate to a handheld electronic communication device, wherein: the second control knob has a base portion and a top portion; the second control knob is oriented in an angled manner within the hollow shroud; and the shroud is tapered from the base portion toward the top portion.

In some aspects, the techniques described herein relate to a handheld electronic communication device, wherein: the edge portion is disposed adjacent to a first side of the housing; and the control interface includes an antenna interface disposed between the first control knob and a second side of the housing.

In some aspects, the techniques described herein relate to a handheld electronic communication device, further including: a selector switch coupled to the control interface; wherein the selector switch is positioned between the first and second control knobs.

In some aspects, the techniques described herein relate to a handheld electronic communication device, further including: a screen coupled to the control interface; wherein the screen is positioned between the first control knob and a front portion of the housing.

In some aspects, the techniques described herein relate to a handheld electronic communication device, wherein the first control knob is a channel selector switch.

In some aspects, the techniques described herein relate to a handheld electronic communication device, wherein the second control knob is one of a volume control and a combination switch including volume and power controls.

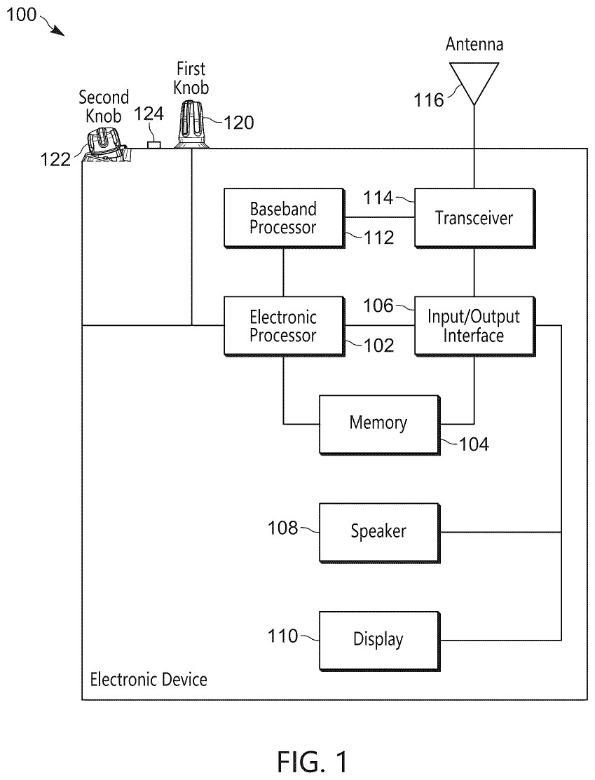

FIG. 1 is a block diagram FIG. 1 is a block diagram of an electronic device 100 according to one exemplary embodiment. In the example illustrated, the electronic device 100 includes an electronic processor 102 (e.g., a microprocessor or another suitable programmable device), a memory 104 (e.g., a computer-readable storage medium), an input/output interface 106, a speaker 108, a display 110, a baseband processor 112 (for example, a network modem), a transceiver 114, an antenna 116, a first control knob 120, a second control knob 122, and a selector switch 124. In a number of the embodiments described herein, the electronic device 100 is a portable two-way radio. However, in alternative embodiments, the electronic device 100 may be a cellular telephone, a smart telephone, a mobile radio, a converged device, a smart watch, a tablet computer, a personal digital assistant (PDA), or other electronic device.

The electronic processor 102, the memory 104, the input/output interface 106, the speaker 108, the display 110, the baseband processor 112, the transceiver 114, the antenna 116, the first control knob 120, the second control knob 122, and the selector switch 124, as well as other various modules and components, are coupled to each other by or through one or more control or data buses, which enable communication therebetween. The use of control and data buses for the interconnection between and exchange of information among the various modules and components would be apparent to a person skilled in the art in view of the description provided herein. The electronic processor 102 controls the other components of the electronic device 100. The electronic processor 102 obtains and provides information (for example, from the memory 104 and/or the input/output interface 106), and processes the information by executing one or more software instructions or modules, capable of being stored, for example, in a random access memory (“RAM”) area of the memory 104 (for example, during execution) or a read only memory (“ROM”) of the memory 104 (for example, on a generally permanent basis) or another non-transitory computer readable medium. The software can include firmware, one or more applications, program data, filters, rules, one or more program modules, and other executable instructions. The electronic processor 102 retrieves from the memory 104 and executes, among other things, software related to control processes and methods for operating the electronic device 100

The memory 104 can include one or more non-transitory computer-readable media, and includes a program storage area and a data storage area. The program storage area and the data storage area can include combinations of different types of memory, as described herein.

The input/output interface 106 receives input from, for example, a user of the electronic device 100, provides system output, or a combination of both. The input/output interface 106 obtains information and signals from, and provides information and signals to, (for example, over one or more wired and/or wireless connections) devices both internal and external to the electronic device 100. Output may be provided via the speaker 108 and the display 110. The speaker 108 may be a transducer for reproducing sound from electrical signals received from the electronic processor 102 via the input/output interface 106. The display 110 is a suitable display device such as, for example, a liquid crystal display (LCD), or an organic light-emitting diode (OLED) touch screen. Alternative embodiments may include other output mechanisms such as, for example, haptic feedback motors and light sources (not shown). Input may be provided via, for example, a keypad, a microphone, soft keys, icons, or soft buttons on the display 110, a scroll ball, buttons, and the like. The input/output interface 106 may include a graphical user interface (GUI) (for example, generated by the electronic processor 102, from instructions and data stored in the memory 104, and presented on the display 110) that enables a user to interact with the electronic device 100.

The baseband processor 112 encodes and decodes digital data, including voice communications, sent and received by the transceiver 114. The electronic processor 102 controls the transceiver 114 to send and receive data to and from various wireless communications and data networks such as, for example, a land-mobile radio (LMR) network (not shown), via the antenna 116.

The first control knob 120 is a rotary knob removably coupled to the electronic device 100. In some aspects, the first control knob 120 is a rotary control channel selector switch. As illustrated herein, in some aspects, the first control knob 120 may have a fluted body. In other examples, the first control knob 120 may have a knurled surface or be otherwise physically configured to facilitate gripping by a user of the electronic device 100. As illustrated herein, the first control knob 120 is substantially cylindrical in form. In some examples, the first control knob 120 may have another suitable shape.

The second control knob 122 is a rotary knob removably coupled to the electronic device 100. In some aspects, the second control knob 122 is a rotary control volume selector switch. In some aspects, the second control knob 122 is a combination control with volume and power control functions. As illustrated herein, the second control knob 122 may have a fluted body. In other examples, the second control knob 122 may have a knurled surface or be otherwise physically configured to facilitate gripping by a user of the electronic device 100. As illustrated herein, the second control knob 122 is substantially cylindrical in form. In some examples, the second control knob 122 may have another suitable shape.

In some configurations, the first control knob 120 and the second control knob 122 are sized similarly. In other configurations, one may be larger than the other. In some configurations, as illustrated herein, the second control knob 122 is shorter and wider than the first control knob 120.

The selector switch 124 may be a slider switch having two or more positions. In some examples, the selector switch 124 allows a user of the electronic device 100 to select from multiple groupings of channels, such that the position of the selector switch 124 partially defines the function of the first control knob 120. The selector switch 124 may be configured to slide between positions in a substantially straight line or along a curve. As described herein, the selector switch 124 may be disposed between the first control knob 120 and the second control knob 122. Example physical configurations of the first control knob 120, the second control knob 122, and the selector switch 124 are described in greater detail below.

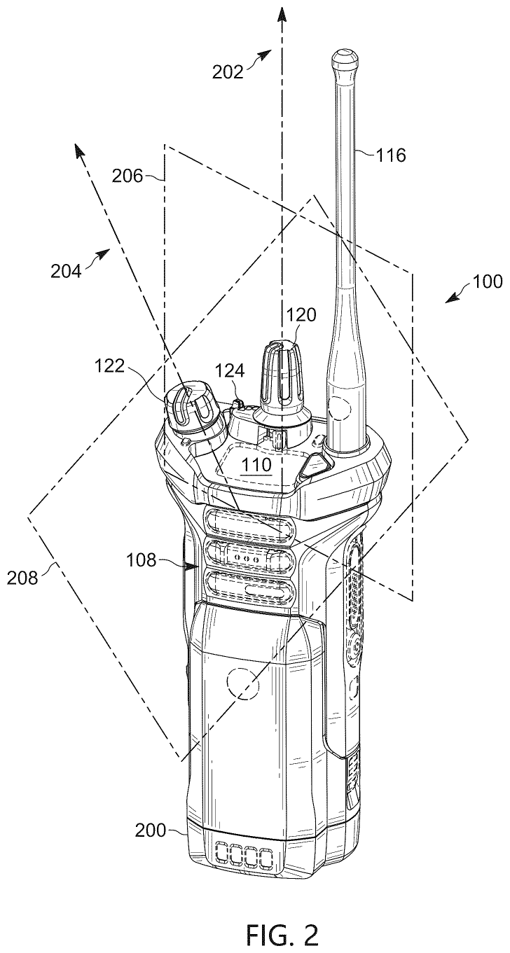

FIG. 2 illustrates a perspective view of the electronic device 100. The electronic device 100 includes a housing 200 that contains various components and controls. The housing 200 may be constructed from a durable material suitable for portable electronic devices.

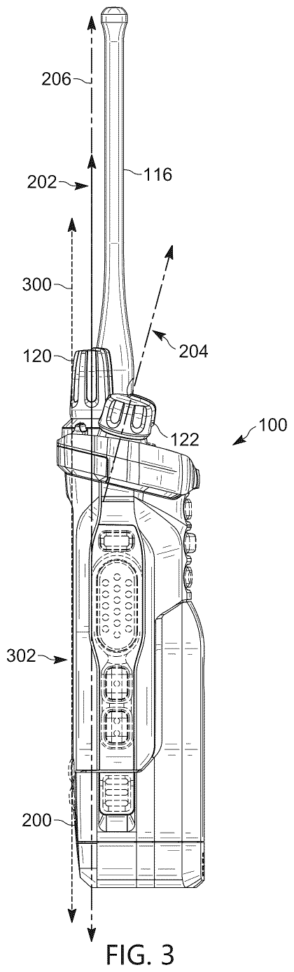

In some instances, the first control knob 120 and the second control knob 122 are positioned on an upper portion of the housing 200. In the illustrated example, the first control knob 120 has a first rotational axis 202 on a first plane 206. The second control knob 122 has a second rotational axis 204 on a second plane 208. As illustrated in FIG. 3, the second control knob 122 is tilted away from the first control knob 120 in two directions, such that the first plane 206 and the second plane 208 are oblique to one another when viewed from every direction. This oblique orientation results in increased spacing between the first control knob 120 and the second control knob 122 while maintaining a compact form factor of the housing 200.

In some configurations, the selector switch 124 may be located between the first control knob 120 and the second control knob 122. In some instances, the distance between the first control knob 120 and the second control knob 122 may be approximately 18 to 19 mm. This spacing may facilitate ease of use, particularly for users wearing gloves or operating the electronic device 100 in challenging environments.

In some instances, the first control knob 120 may be a channel selector switch. The first control knob 120 may allow a user to select different communication channels for the electronic device 100. The second control knob 122 may be a combination switch including volume and power controls. The second control knob 122 may allow a user to adjust the volume of audio output from the speaker 108 and control the power state of the electronic device 100.

As illustrated, the antenna 116 may extend upward from the top of the housing 200. The display 110 may be integrated into the housing 200, providing visual information to the user. The positioning of these elements, along with the first control knob 120, the second control knob 122, and the selector switch 124, may create an ergonomic and functional layout for the electronic device 100.

FIG. 3 illustrates a side orthogonal view of the electronic device 100. In some aspects, a third plane 300 is defined by a portion of the rear surface 302 of the housing 200. This configuration may provide a reference plane for aligning and positioning various components of the electronic device 100. In some aspects, the third plane 300 may be parallel to the first plane 206 and oblique to the second plane 208.

With reference to FIG. 3, one can view the ergonomic spacing created between the first control knob 120 and the second control knob 122 by the orientation of the second control knob 122 (described with respect to FIG. 2). This arrangement allows for efficient use of space on the upper portion of the housing 200 while providing clear access to both control knobs for gloved users. For example, the second control knob 122 may be oriented at an angle relative to both the first rotational axis 202 and the first control knob 120. In some instances, the second control knob 122 may be tilted with respect to the first control knob 120 and the third plane 300. As described herein, this angled orientation may create a specific spatial relationship between the control elements while maintaining their accessibility.

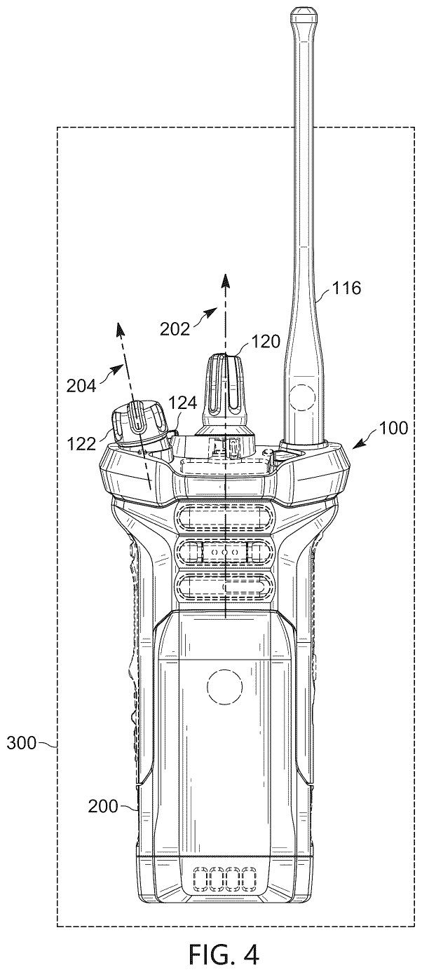

FIG. 4 illustrates a front orthogonal view of the electronic device 100. The front orthogonal view demonstrates the angular positioning of the first and second control knobs, with the second control knob 122 being oriented at an oblique angle relative to the first control knob 120 in two dimensions.

In some instances, the selector switch 124 may be positioned between the first control knob 120 and the second control knob 122. This arrangement may allow for efficient use of space on the upper portion of the housing 200 while providing clear access to both control knobs and the selector switch 124.

The antenna 116 may extend vertically from the housing 200 and may be positioned adjacent and slightly forward of the first control knob 120. This configuration may contribute to the overall compact design of the electronic device 100 while maintaining optimal antenna performance.

In some instances, the housing 200 may feature a contoured design with various surface details and transitions that accommodate the positioning of the control elements. As noted, the angular arrangement of the first control knob 120 and the second control knob 122, as visible in the front orthogonal view, may enhance the ergonomics and usability of the electronic device 100, particularly for users operating the device with gloved hands or in challenging environments.

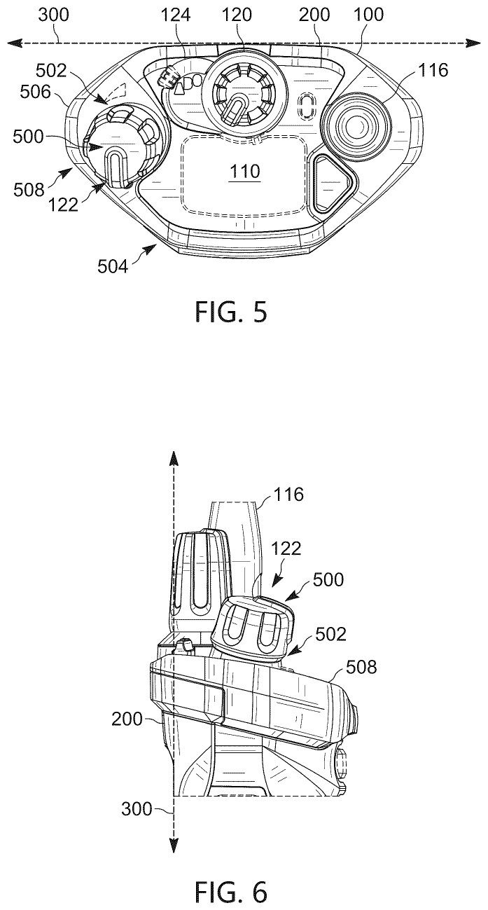

FIG. 5 illustrates a top orthogonal view of the electronic device 100. FIG. 6 illustrates a partial side orthogonal view of the electronic device 100. The second control knob 122 comprises a top portion 500 and a base portion 502, as shown in FIG. 5 and FIG. 6. The base portion separated 502 is separated from the third plane 300 by a first distance. The top portion is separated from the third plane 300 by a second distance. In some instances, the second control knob 122 may be aligned to cause the second distance to be substantially greater than the first distance. This alignment creates an angled orientation of the second control knob 122, as described herein and illustrated in the figures.

The housing 200 includes a control interface 504, which may include various controls, such as the first control knob 120 and the second control knob 122. As illustrated in FIG. 5, the control interface 504 also includes the display 110 and the selector switch 124. The selector switch 124 may be coupled to the control interface 504. In some instances, the selector switch 124 may be positioned between the first control knob 120 and the second control knob 122. This arrangement may allow for efficient use of space on the upper portion of the housing 200 while providing clear access to both control knobs and the selector switch 124.

In some instances, as illustrated in FIG. 5, the second control knob 122 may project along the edge portion 506 of the control interface 504. This positioning may allow for easy access to the second control knob 122 while maintaining a compact form factor for the electronic device 100.

In some aspects, the housing includes, along the edge portion 506, a shroud 508. As illustrated in FIGS. 5 and 6, the shroud 508 may be hollow and envelop a portion of the second control knob 122. As illustrated, the second control knob 122 may be oriented in an angled manner within the shroud 508. The shroud 508 may be tapered from the base portion toward the top portion of the second control knob 122, as depicted in FIG. 6. This tapered design of the shroud 508 may accommodate the angled orientation of the second control knob 122. The tapered shroud 508 and the angled positioning of the second control knob 122 may contribute to the ergonomic design of the electronic device 100. The angled orientation of the second control knob 122 and the tapered design of the shroud 508, as shown in FIG. 5 and FIG. 6, may facilitate improved grip and control for users, particularly when operating the electronic device 100 with gloved hands or in challenging environments.

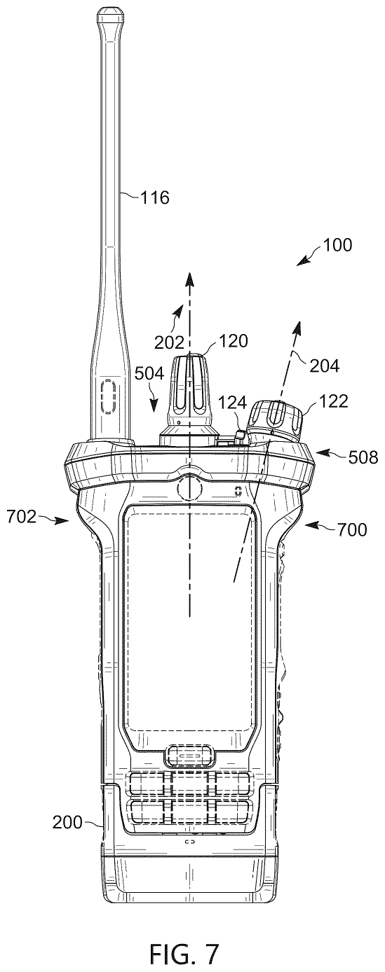

FIG. 7 illustrates a front orthogonal view of the electronic device 100. As illustrated, the housing 200 includes a first side 700 and a second side 702 positioned opposite the first side 700. The edge portion 506 is disposed adjacent to the first side 700. The antenna 116 couples to the control interface 504 via an antenna interface. In some instances, the antenna interface may be disposed between the first control knob 120 and the second side 702 of the housing 200. This arrangement may further contribute to the ergonomic design of the electronic device 100, allowing for efficient use of space while maintaining accessibility of the control elements.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A handheld electronic communication device comprising:
a first control knob having a first rotational axis on a first plane; and
a second control knob having a second rotational axis on a second plane;
wherein the first and second planes are oblique to one another when viewed from every direction.

2. The handheld electronic communication device of claim 1, further comprising:
a housing including a rear surface;
wherein a portion of the rear surface defines a third plane parallel to the first plane and oblique to the third plane.

3. The handheld electronic communication device of claim 2, wherein:
the second control knob has a base portion separated from the third plane by a first distance and a top portion separated from the third plane by a second distance; and
the second control knob is aligned to cause the second distance to be substantially greater than the first distance.

4. The handheld electronic communication device of claim 1, further comprising:
a housing including a control interface;
wherein the first control knob and the second control knob are coupled to the control interface.

5. The handheld electronic communication device of claim 4, wherein:
the control interface includes an edge portion;
the second control knob projects along the edge portion; and
the housing includes a hollow shroud projecting from the control interface and enveloping a portion of the second control knob.

6. The handheld electronic communication device of claim 5, wherein:
the second control knob has a base portion and a top portion;
the second control knob is oriented in an angled manner within the hollow shroud; and
the shroud is tapered from the base portion toward the top portion.

7. The handheld electronic communication device of claim 5, wherein:
the edge portion is disposed adjacent to a first side of the housing; and
the control interface includes an antenna interface disposed between the first control knob and a second side of the housing.

8. The handheld electronic communication device of claim 4, further comprising:
a selector switch coupled to the control interface;
wherein the selector switch is positioned between the first and second control knobs.

9. The handheld electronic communication device of claim 4, further comprising:
a screen coupled to the control interface;
wherein the screen is positioned between the first control knob and a front portion of the housing.

10. The handheld electronic communication device of claim 1, wherein the first control knob is a channel selector switch.

11. The handheld electronic communication device of claim 1, wherein the second control knob is one of a volume control and a combination switch including volume and power controls.
